(19) United States
(12) Patent Application Publication
(10) Pub. No.: US 2003/0039465 A1
(43) Pub. Date: Feb. 27, 2003

(54) Systems for selectively associating cues with stored video frames and methods of operating the same

(75) Inventors: Stephen Bjorgan, San Francisco, CA (US); Robert Noakes, Walnut Creek, CA (US)

Correspondence Address: DAVIS MUNCK, 900 THREE GALLERIA TOWER, 13155 NOEL ROAD, DALLAS, TX, 75240, US

(73) Assignee: FRANCE TELECOM RESEARCH AND DEVELOPMENT L.L.C., Brisbane, CA

(21) Appl. No.: 10/126,485

(22) Filed: Apr. 19, 2002

Related U.S. Application Data
(60) Provisional application No. 60/285,392, filed on Apr. 20, 2001.

(51) Int. Cl. H04N 9/89

(52) U.S. Cl. 386/20

(57) ABSTRACT

Disclosed systems for selectively associating cues with stored video frames, and methods of operation. An exemplary video processing system comprises a video recording system and a video playback system. The video recording system (i) receives a digital content stream and (ii) stores the video track data associated therewith as video frames in a storage device. The video recording system comprises a content detection controller operable, in response to received content descriptor data, to (i) detect a subset of the video frames associated with select content in the received digital content stream, and (ii) associate a cue with at least one of the subset of the video frames.

### TECHNICAL FIELD OF THE INVENTION

The present invention is directed, in general, to mix Internet/broadcast systems and, more specifically, to systems and system platforms for associating cues with stored video frames and methods of operating the same.

### BACKGROUND OF THE INVENTION

In conventional television (“TV”) systems, television commercials may be inserted into a video program stream at a television broadcast facility. The video program stream, including the inserted commercials, is then transmitted wirelessly or by a cable system to all television receivers within range of the station. However, inserting commercials at a particular broadcast facility has certain drawbacks. Some very large television stations that are centered in certain home markets, such as New York, Chicago, or Atlanta, are also available in other cities outside the home markets. However, those video streams broadcast from those stations contain local advertising specific to the home market. This advertising is of little value outside the home market.

There are well-known video processing systems that replace an original commercial advertisement in a broadcast television signal with a substitute commercial advertisement. The substitute commercial is targeted to a specific demographic group that is likely to find the substitute commercial of greater value the original commercial advertisement. The replacement can be done at various points of the delivery chain, for example, at local affiliates of a network.

There are other reasons for replacing commercials in a video stream. One primary reason is the rebroadcast of television programs containing dated commercials. Many commercials are of a time-limited nature. A commercial advertisement for the 2001 World Series that occurs during a television situation comedy (or sitcom) is of little value if the sitcom is rebroadcast in 2002, 2003, or later. Similarly, a commercial may announce that a product is offered for sale at particular price in 2001. This price is unlikely to be valid in subsequent years. Moreover, when the commercial is rebroadcast, the product may no longer in production or the manufacturer may no longer be in business, or both. Even in the short run, a commercial that is tied to a particular event is of little value after the event has occurred. Hence, commercials for Mother's Day sales and Christmas sales are of no value the day after Mother's Day and Christmas, respectively.

This time-limited nature of commercials is a particularly important drawback with respect to home recording of television programs. A viewer may use a video cassette recorder (VCR) or a video disk recorder (VDR) to record a broadcast television program that the viewer views at a later time. This time-shifted viewing provides great convenience to consumers, but often renders recorded commercials useless. If a viewer records a television program the week before Thanksgiving and watches it the week after Thanksgiving, all recorded commercials related to Thanksgiving, including sales offers that expire on Thanksgiving, are essentially useless.

Moreover, commercials are often, if not usually, directed to a particular type of audience. While some may have universal appeal, more frequently both the type of product being advertised, and the way in which the message is conveyed, are calculated to resonate with a particular demographic group. Beer and wine commercials, for example, are targeted at an audience old enough to enjoy these products, while advertisements for toys and games are often designed to appeal to young viewers. Fast-food restaurants may want to appeal to both groups but use different messages for doing so. For example, young purchasers may be attracted by exciting, fast-moving offers of free toys accompanied by a modern music medley, while an appeal to their parents might include a thoughtful demonstration of the healthy food choices that are available at the restaurant, perhaps with nature sounds audible in the background. Audience targeting, of course, can currently be performed by matching, as closely as possible, the types of commercials with the types of programs they accompany. But predicting the demographic profile of the viewers of a certain program and what ads will appeal to them can sometimes be difficult, at least until a good deal of historical evidence has been gathered. And the timeshifting phenomenon, described above, may not only result in anachronous commercial messages, but may also result in a viewing audience that is different from one originally predicted.

People vary too, of course, and often have needs and interests that are not normally associated with the demographic profile into which they happen to fall. Such an audience may be particularly difficult to target, since there are few accurate ways, if any, to predict their viewing habits or the type of advertising that will appeal to them.

Therefore, there exists a need in the art for improved video processing systems that enable providers of broadcast video and other programming to more accurately target secondary content toward the current needs of the specific audience viewing their primary content programming at any given time.

### SUMMARY OF THE INVENTION

To address the above-discussed deficiencies of the prior art, it is a primary object of the present invention to provide, for use in a digital broadcast environment, systems and system platforms for cueing and inserting content data into a digital content stream comprising video track data, audio track data and content descriptor data and methods of operating the same.

According to an advantageous embodiment of one invention hereof, intelligent systems are provided for inserting cues into the broadcast content stream. One important aspect of this embodiment is the use of a cue to insert “secondary” content into a “primary” content stream. For purposes of illustration, there are disclosed systems and system platforms for selectively associating cues with stored video frames. According to one embodiment, an exemplary video processing system comprises a video recording system and a video playback system.

The video recording system is capable of (i) receiving a digital content stream comprising video track data, audio track data and content descriptor data and (ii) storing the video track data as video frames in a storage device. The video recording system comprises a commercial detection controller operable, in response to the received content descriptor data, to (i) detect a subset of the video frames associated with a commercial in the received digital content stream, and (ii) associate a cue with at least one of the subset of the video frames.

The video playback system is capable of playing back the stored video track data, and comprises a video playback controller operable to detect cues associated with ones of the subsets of the video frames and to direct the video playback system in response thereto to selectively replace the commercial with a substitute commercial during playback.

Embedding cues in digital content, or media, streams facilitates the creation of applications that are capable of receiving and processing one or more digital content streams. Controllers implementing these media processing applications may suitably be implemented at a video processing system (e.g., television, set top box, video cassette recorder, video storage system, etc.), or at a network intermediary (e.g., gateway, proxy, etc.).

Those skilled in the art will understand that such applications may suitably be used, for instance, in an alternate video recording system that comprises more broadly a content detection controller operable, in response to the received content descriptor data, to (i) detect a subset of the video frames associated with a select content in the received digital content stream, and (ii) associate a cue with at least one of the subset of the video frames.

Exemplary “cues,” as the term is broadly used herein are machine-readable binary codes. Preferably, the cues are variable in size, format and density of information provided, and may suitably be used to form a matrix of at least one dimension having data contained therein. An important aspect of alternate embodiments hereof is that the format of a given cue as well as the position of insertion into a content stream may suitably be based upon the particular application being executed. Stated differently, a cue may be any suitably arranged binary code that is in the form of a data packet or a portion thereof (e.g., header-based, data-based, etc.).

Another important aspect of this invention is the use of a cue to selectively replace a commercial or other content within a subset of the video frames with a substitute commercial or other content during playback. This may suitably be to replace select content, such as an “expired” commercial or, alternatively, to present a “targeted” commercial, such targeting possibly based, at least in part, upon the economic characteristics of a particular geographic location, possibly identified by zip code, though other measurable characteristics concerning the viewing/listening audience, including demographics data (e.g., age, sex, income, etc.), usage patterns, dynamic and/or static profiles, purchase history and the like, all of which are within the scope of this invention.

The foregoing has outlined rather broadly the features and technical advantages of the present inventions so that those skilled in the art may better understand the detailed description that follows. Additional features and advantages of the inventions will be described hereinafter. Those skilled in the art should appreciate that they may readily use the conception and the specific embodiment disclosed as a basis for modifying or designing other structures for carrying out the same purposes of the present inventions. Those skilled in the art should also realize that such equivalent constructions do not depart from the spirit and scope of the invention in its broadest form.

Before undertaking the detailed description, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” and “processor” mean any device, system or part thereof that controls at least one operation, such a device may be implemented in hardware, firmware or software, or some combination of at least two of the same. It should be noted that the functionality associated with any particular controller/processor may be centralized or distributed, whether locally or remotely. In particular, a controller/processor may comprise one or more data processors, and associated input/output devices and memory, which execute one or more application programs or an operating system program. Definitions for certain words and phrases are provided throughout this patent document, those of ordinary skill in the art should understand that in many, if not most instances, such definitions apply to prior, as well as future uses of such defined words and phrases.

### BRIEF DESCRIPTION

For a more complete understanding of the present inventions, and the advantages thereof, reference is now made to the following descriptions taken in conjunction with the accompanying drawings, wherein like numbers designate like objects, and in which:

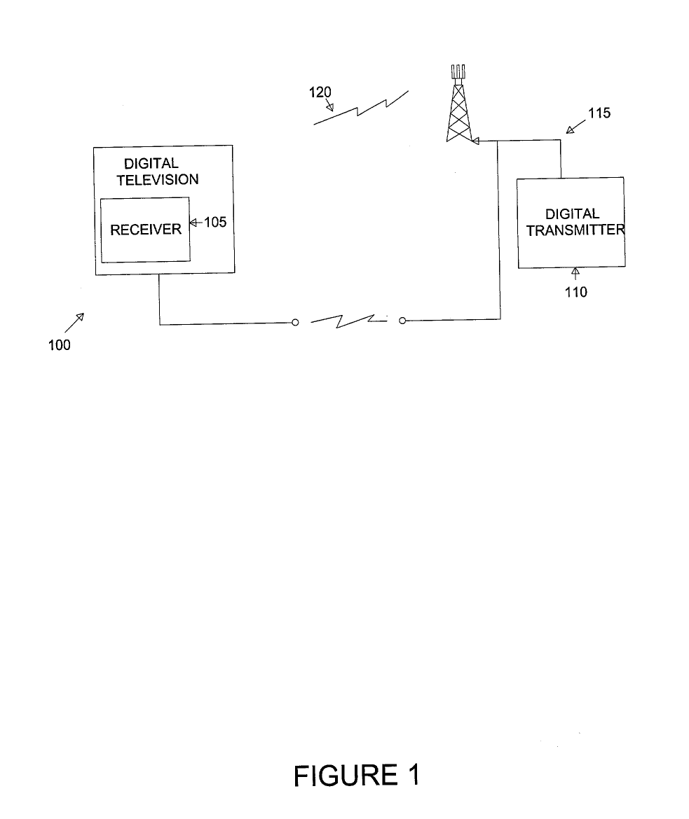

FIG. 1 illustrates a conceptual block diagram of a digital television according to one embodiment of the present invention;

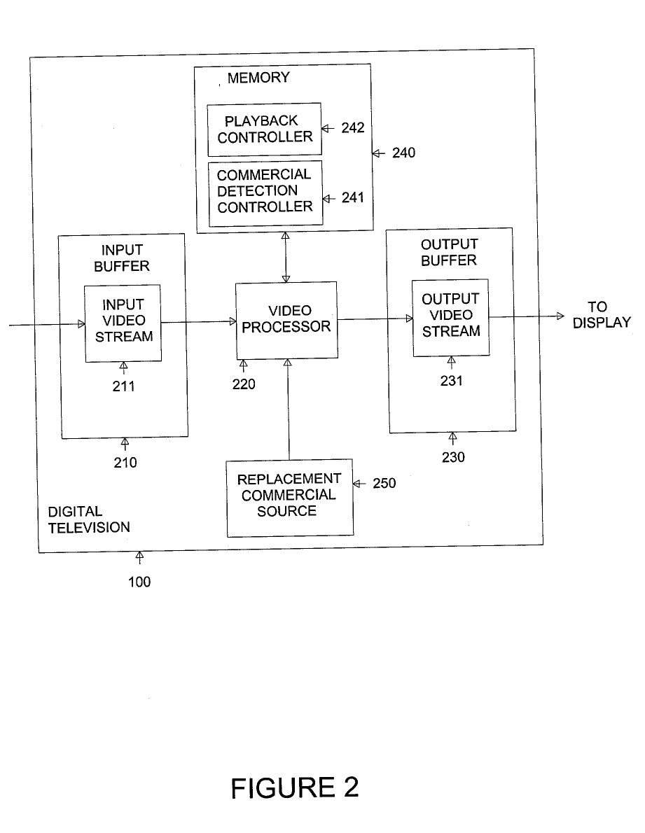

FIG. 2 illustrates in greater detail selected portions of digital video processing system 100 according to the embodiment of FIG. 1.

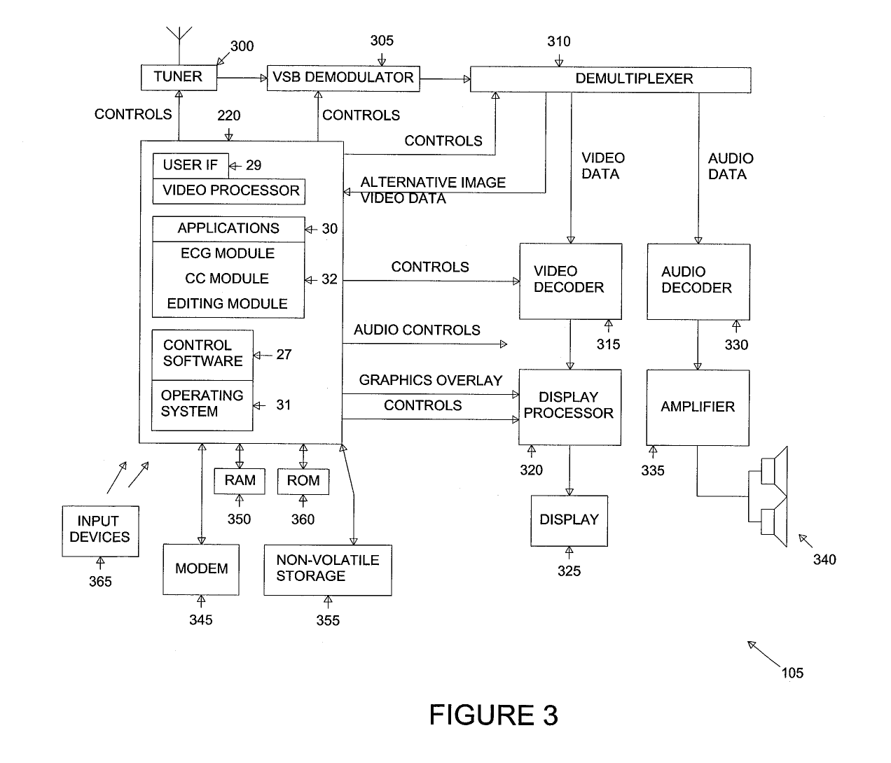

FIG. 3 illustrates a block diagram of a digital television receiver according to the embodiment of FIGS. 1 and 2; and

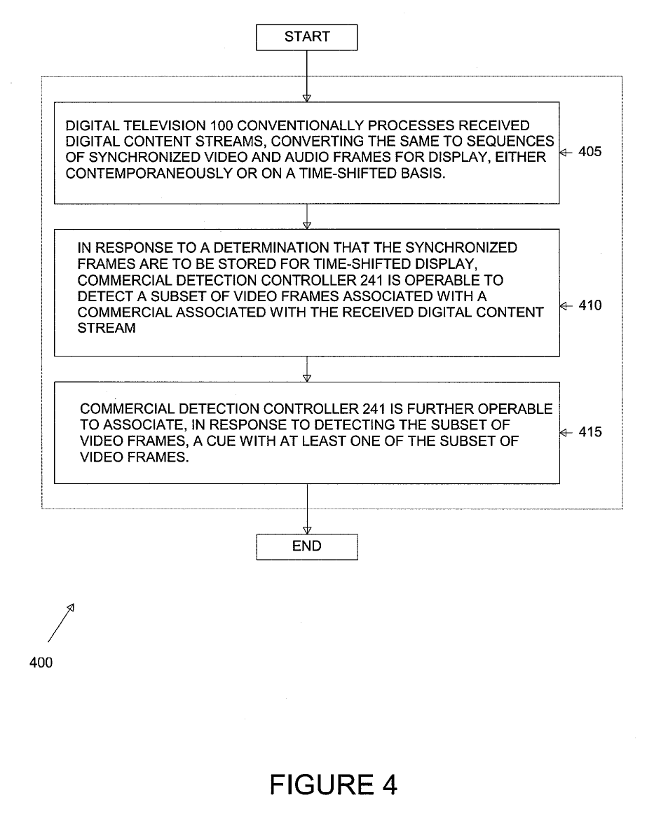

FIG. 4 illustrates a flow diagram of an exemplary method of operating the digital television according to the embodiment of FIGS. 1 to 3.

### DETAILED DESCRIPTION

FIGS. 1 through 4, discussed below, and the various embodiments used to describe the principles of the present inventions in this patent document are by way of illustration only and should not be construed in any way to limit the scope of the inventions set forth herein. Those skilled in the art will understand that the principles of the present inventions may be implemented in any suitably arranged content broadcast system, including, for instance, television, digital cinema, radio, etc.

FIG. 1 illustrates a conceptual block diagram of a digital television (generally designated 100) according to one embodiment of the present invention. Digital television 100 is an exemplary video processing system in accordance with the principles of the present invention. Digital television 100 illustratively includes a digital receiver 105, a transmitter 110, and a transmission medium 115.

Exemplary transmission medium 115 may suitably be a coaxial cable, fiber-optic cable, or the like, over which digital content streams may be transmitted transmitter 110 and digital receiver 105. Transmission medium 115 may include a radio frequency (“RF”) link between at least portions thereof, for instance, content data may be transmitted between transmitter 110 and digital receiver 105 via an RF link, such as RF link 120. Exemplary digital content streams comprise video track data, audio track data and content descriptor data. Transmitter 110 may suitably be located at a centralized broadcast facility, such as a television station or studio, from which the digital content streams may be transmitted to digital television receivers.

In an illustrative embodiment, the video and audio track data are encoded, preferably at the centralized broadcast facility, prior to transmission. For instance, the audio track data may be encoded in AC3 format and the video track data may be encoded in Motion Picture Experts Group (“MPEG”) coding, and, in particular, MPEG-2 or higher format. Other suitable formats may suitably be substituted based upon the application.

Exemplary video track data comprises a video sequence that, for instance, may include one or more television programs and television advertising (i.e., commercials) that are associated with the television programs. Exemplary audio track data comprises sound associated with corresponding portions of the video track data.

FIG. 2 illustrates in greater detail selected portions of the digital video processing system, digital television 100, according to the embodiment of FIG. 1. Digital television 100 illustratively comprises input buffer 210, video processor 220, output buffer 230, memory 240, and replacement commercial source 250 (in alternate embodiments, an alternate content source may suitably be used, such as alternate programming or sub-programming content).

According to this embodiment, input buffer 210, video processor 220, output buffer 230, memory 240, and replacement commercial source 250 cooperate to provide a video recording system in accord with the principles of the present invention. The video recording system is operable to (i) receive digital content streams comprising video track data, audio track data and content descriptor data, (ii) conventionally process the same in video processor 220 to convert (e.g., decode, decompress, translate, etc.) the same to a sequence of synchronized video and audio frames for display, and (iii) display the same to a display device using output buffer 230 as temporary storage or, alternatively, store such processed sequences of video/audio frames in a storage device, such as memory 240, for time shift display.

Memory 240 stores commercial detection controller 241 (in alternate embodiments, an alternate content detection controller may suitably be used, such as alternate programming or sub-programming detection), which is executable by video processor 220. Exemplary commercial detection controller 241 contains, among other things, the code for controlling the interactive cooperation between a main content source and from one to a plurality of secondary content sources. According to an advantageous embodiment of the present invention, memory 340 may comprise a removable media drive, such as a CD-ROM drive and commercial detection controller 241 may be instantiated from a removable media disk.

In the event that processed sequences of video/audio frames are to be stored for time shift display, exemplary commercial detection controller 241 is operable, in response to received content descriptor data associated therewith, to (i) detect subsets of the audio or video frames associated with a commercial (or other select content in alternate embodiments) within the received digital content stream, and (ii) selectively associate one or more cues with at least one of the audio or video frames of the subset of the same. In accordance herewith, the cue is operable to cause a playback controller 242 (also illustratively stored in memory 240) to selectively replace the commercial with a substitute commercial during playback of the stored video track data. It is important to note that video processor 220, depending upon its implementation, may suitably convert the digital content streams a sequence of synchronized analog video and audio frames, thereby forming an analog content stream.

Again, cues may include clocking data associated with the commercial (or other select content) and, according to one advantageous embodiment, the clocking data includes at least one of either the start time of the commercial (or other select content) or the duration time of the commercial (or other select content). Cues may also include at least one of either content indicia associated with the received digital content stream or a subscriber profile.

In playback mode, exemplary playback controller 242 directs video processor 220 to retrieve the stored sequences of video/audio frames that may suitably include one or more associated cues and to store the same in output buffer 230. More particularly, operating under the control of playback controller 242, video processor 220 retrieves each frame from memory 240 and parses each of the same for associated cues. Upon detection of a cue, playback controller 242 processes the same to determine whether any frames associated with a commercial (or other select content) should be replaced, to thereby selectively replace certain commercials (or other select content) with substitute commercials (or other content) during playback. According to this embodiment, such substitute commercials (or other content) are illustratively provided through replacement commercial source 250. Of course, in alternate embodiments, replacement commercial source 250 may comprise any known storage device, including a hard disk drive, CD-ROM drive, and DVD drive, a VCR tape, or a network feed over which another incoming digital content stream is being received, and may include alternate non-commercial content.

Examples of applications that may suitably be eased by the embedding of cues include advertising, recording, insertion, switching, adaptation and the like. Such applications typically require relatively exact time synchronization with arriving media packets to operate correctly. Failure to maintain precise time synchronization (e.g., say when switching between two or more source streams) may result in undesired perceptible artifacts when the resulting stream is rendered. Such time synchronization between applications and media streams is also required in implementations where relatively little media packet buffering is available at a stream processing point; for example, in wireless devices and Internet appliances.

The cueing methodology of the present invention may also be used to insert advertisements, messages, user queries, other content and the like at discreet positions within broadcast programming (e.g., radio, television, etc.), wherein programming may suitably be live, time-shifted or some suitable combination thereof.

FIG. 3 illustrates a detailed block diagram of video processing system receiver, digital receiver 105, according to the embodiment of FIGS. 1 and 2. Exemplary digital receiver 105 illustratively includes a tuner 300, a VSB demodulator 305, a demultiplexer 310, a video decoder 315, a display processor 320, a display screen 325, an audio decoder 330, an amplifier 335, speakers 340, video processor 220, a modem 345, a random access memory (“RAM”) 350, a non-volatile storage 355, a read-only memory (“ROM”) 360, and input devices 365. Each of the foregoing features of digital receiver 105 is known in the art; however, descriptions are provided for completeness.

Tuner 300 comprises a standard analog RF receiving device capable of receiving an analog signal that includes analog video and audio data. Tuner 300 may receive this signal from either transmission medium 115 or via RF link 120 over a particular frequency channel. Demodulator 305 receives the input analog signal from tuner 300 and, based on control signals received from the video processor 220, converts the analog signal into digital data packets. These data packets are then output to demultiplexer 310. Demultiplexer 310 receives the data packets output from demodulator 305 and “desamples” the same, meaning that the packets are output either to video decoder 315the audio decoder 330 or video processor 220 depending upon an identified packet type.

Video processor 220 identifies whether data packets from the demultiplexer 310 include video track data, audio track data, or content descriptor data, and causes the data packets to be output accordingly.

Stated differently, video data is output to video decoder 315, audio data is output to audio decoder 330, and content descriptor data are output to the video processor 220. In an alternative embodiment, the data packets are output from the demodulator 305 directly to video processor 220. According to the same, video processor 220 performs the tasks of the demultiplexer 310. Specifically, in this embodiment, video processor 220, receives the data packets, desamples the data packets, and then outputs the data packets based on the type of data stored therein. In this embodiment, however, video processor 220 retains the content descriptor data.

The video decoder 315 decodes video data packets received from the demultiplexer 310 (or from video processor 220) in accordance with control signals, such as timing signals and the like, received from video processor 220. In an advantageous embodiment, the video decoder 315 is an MPEG-2 decoder; however, any decoder may be used so long as it is compatible with the type of coding used to code the video data. The decoded video data may then transmitted to display processor 320, or, if time shifted play back is intended, stored to memory 240, as described hereinabove.

Display processor 320 forms images from video data and outputs those images to display screen 325. In operation, display processor 320 outputs a video sequence in accordance with control signals received from video processor 220 based on the decoded video data received from video decoder 315 and based on graphics data received from video processor 220. More specifically, display processor 320 forms images from the decoded video data received from video decoder 315 and from any graphics data received from video processor 220, and inserts the images formed from the graphics data at appropriate points in the video sequence defined by the images formed from the decoded video data.

Audio decoder 330 is used to decode audio track data associated with video track data displayed on display screen 325. In preferred embodiments of the invention, the audio decoder 330 comprises an AC3 audio decoder; however, other types of audio decoders may be used in conjunction with the present invention depending, of course, on the type of coding used to code the audio data. Audio decoder 330 operates in accordance with audio control signals received from video processor 220. These audio control signals include timing information and the like, and may include information for selectively outputting the audio data. Output from the audio decoder 330 is provided to the amplifier 335. The amplifier 335 comprises a conventional audio amplifier that adjusts an output audio signal in accordance with audio control signals relating to volume or the like input via the input devices 365. Audio signals adjusted in this manner are then output via the speakers 340.

Video processor 220 is capable of executing stored program instructions to control operations of digital receiver 105. These program instructions comprise parts of software modules (described with reference to FIG. 4) that are stored in either an internal memory of video processor 220 or in RAM 350 or ROM 360. These software modules may be updated via the modem 345 and/or via the MPEG-2 bit stream. Stated differently, video processor 220 receives data from the modem 345 or via the bit stream that may include software module updates, video data (e.g., graphics data or the like), audio data, and a user profile.

A user profile comprises information relating to one or more viewers of digital receiver 105, and is used in the method for selecting an alternate, or secondary, content stream, which is described in previously incorporated United States Patent Application No. ______, (Attorney-Docket No. 00005). The user profile may be stored anywhere within digital receiver 105, but, in alternate embodiments, the user profile may be stored in non-volatile storage 355. User profiles may, of course, be implemented in static or dynamic memory.

An important aspect of the implementation of this invention is that embodiments of any video processing system, such as digital television 100, may have control housed internally, such as within a digital receiver, within a set-top box, or distributed. For instance, video processor 220 above, or its substantial equivalent, may be housed in the set-top box, together with a memory that includes software modules executed thereby. In this embodiment, the digital receiver is controlled based on control signals from the set-top box, and will itself include one or more processors, such as the display processor 320 described above, for performing necessary control functions as well as video and audio display functions. Thus, although the invention can be implemented using different controller configurations, for the sake of brevity, the following assumes that the controllers reside in the digital television receiver itself.

Broadly, disclosed are systems for selectively associating cues with stored audio and video frames, and methods of operating the same. According to the foregoing embodiment, digital television system 100 comprises a video recording system and a video playback system. The video recording system is capable of (i) receiving a digital content stream comprising video track data, audio track data and content descriptor data and (ii) storing at least the video track data as video frames in a storage device. The video recording system comprises a commercial detection controller 241 (again, in alternate embodiments, an alternate content detection controller may suitably be used, such as alternate programming or sub-programming detection) operable, in response to the received content descriptor data, to (i) detect a subset of the video frames associated with a commercial in the received digital content stream, and (ii) associate a cue with at least one of the subset of the video frames. The video playback system is capable of playing back the stored video track data, and comprises a video playback controller 242 operable to detect cues associated with ones of the subsets of the video frames and to direct the video playback system in response thereto to selectively replace the commercial with a substitute commercial during playback.

FIG. 4 illustrates a flow diagram (generally designated 400) of an exemplary method of operating the video processing system, digital television 100, according to the embodiment of FIGS. 1 to 3. For purposes of illustration, concurrent reference is made to these embodiments.

To begin, digital television 100 conventionally operates (process step 405) to (i) receive digital content streams comprising video track data, audio track data and content descriptor data, (ii) continuously process the received digital content streams in video processor 220 to convert the same to a sequence of synchronized video and audio frames for display, and one of (iiia) display the synchronized frames to display 325 using output buffer 230 as temporary storage, or (iiib) store such synchronized frames in a storage device, such as memory 240, for time shifted display.

In the event that the synchronized frames are to be stored for time-shifted display, commercial detection controller 241 is operable to detect, in response to processing the received content descriptor data, a subset of video frames associated with a commercial (or other select content in alternate embodiments) associated with the received digital content stream during the processing thereof (process step 410).

Commercial detection controller 241 is further operable to associate, in response to detecting the subset of video frames, a cue with at least one of the subset of video frames (process step 415). Advantageously, the cue is operable, upon perception by video playback controller 242 during playback, to selectively direct video playback controller 242 to replace the commercial with a substitute commercial. Digital television 100 then stores the synchronized frames associated with one or more cues in a storage device for time-shifted display, as described hereinabove.

Although the present invention has been described in detail, those skilled in the art should understand that they can make various changes, substitutions and alterations herein without departing from the spirit and scope of the invention in its broadest form.

What is claimed is:

1. A video recording system capable of (i) receiving a digital content stream comprising video track data, audio track data and content descriptor data and (ii) storing said video track data as video frames in a storage device, said video recording system comprising:
a content detection controller operable, in response to said received content descriptor data, to (i) detect a subset of said video frames associated with select content in said received digital content stream, and (ii) associate a cue with at least one of said subset of said video frames, said cue operable to cause a video playback controller to selectively replace said select content with substitute content during playback of said stored video track data.

2. The video recording system set forth in claim 1 further comprising a processor that is operable to convert said received video track data into video frames.

3. The video recording system set forth in claim 1 further comprising a processor that is operable to convert said received digital content stream into an analog content stream.

4. The video recording system set forth in claim 1 wherein said cue includes clocking data associated with said select content.

5. The video recording system set forth in claim 4 wherein said clocking data includes at least one of a start time of said select content and a duration time of said select content.

6. The video recording system set forth in claim 1 wherein said cue includes at least one of content indicia associated with said received digital content stream and a subscriber profile.

7. The video recording system set forth in claim 1 further comprising a display controller that receives said video frames and provides said video frames as a video sequence to a display.

8. A method of operating a video recording system that operates to receive a digital content stream comprising video track data, audio track data and content descriptor data, to process said received digital content stream, and to store said video track data as video frames in a storage device, said method of operating said video recording system comprising the steps of:
detecting, in response to processing said received content descriptor data, a subset of said video frames associated with a commercial in said received digital content stream; and
associating, in response to detecting said subset of said video frames, a cue with at least one of said subset of said video frames, said cue operable to cause a video playback controller to selectively replace said commercial with a substitute commercial during playback of said stored video track data.

9. The method of operating the video recording system set forth in claim 8 further comprising the step of converting said received video track data into video frames.

10. The method of operating the video recording system set forth in claim 8 further comprising the step of converting said received digital content stream into an analog content stream.

11. The method of operating the video recording system set forth in claim 8 further comprising the step of including clocking data associated with said commercial in said cue.

12. The method of operating the video recording system set forth in claim 11 further comprising the step including at least one of a start time of said commercial and a duration time of said commercial in said clocking data.

13. The method of operating the video recording system set forth in claim 8 further comprising the step of including at least one of content indicia associated with said received digital content stream and a subscriber profile in said cue.

14. The method of operating the video recording system set forth in claim 8 further comprising the step of receiving said video frames at a display controller and providing said video frames as a video sequence to a display.

15. A commercial detection controller for association with a video recording system that operates to (i) receive a digital content stream comprising video track data, audio track data and content descriptor data and (ii) store said video track data as video frames in a storage device, said commercial detection controller operable, in response to said received content descriptor data, to (i) detect a subset of said video frames associated with a commercial in said received digital content stream, and (ii) associate a cue with at least one of said subset of said video frames, said cue operable to cause a video playback controller to selectively replace said commercial with a substitute commercial during playback of said stored video track data.

16. The commercial detection controller set forth in claim 15 wherein said cue includes clocking data associated with said commercial.

17. The commercial detection controller set forth in claim 16 wherein said clocking data includes at least one of a start time of said commercial and a duration time of said commercial.

18. The video recording system set forth in claim 15 wherein said cue includes at least one of content indicia associated with said received digital content stream and a subscriber profile.

19. The video recording system set forth in claim 15 further comprising a display that is operable to display said video frames and a display controller that receives said video frames and provides said video frames as a video sequence to said display.

20. A method of operating a commercial detection controller, said commercial detection controller associated with a video recording system that operates to: (1) receive a digital content stream comprising video track data, audio track data and content descriptor data, (2) process said received digital content stream, and (3) store said video track data as video frames in a storage device, said method of operating said commercial detection controller comprising the steps of:
detecting a subset of said video frames associated with a commercial in said received digital content stream; and
associating, in response to detecting said subset of said video frames, a cue with at least one of said subset of said video frames, said cue operable to cause a video playback controller to selectively replace said commercial with a substitute commercial during playback of said stored video track data.

21. The method of operating the commercial detection controller set forth in claim 20 further comprising the step of including clocking data associated with said commercial in said cue.

22. The method of operating the commercial detection controller set forth in claim 21 further comprising the step including at least one of a start time of said commercial and a duration time of said commercial in said clocking data.

23. The method of operating the commercial detection controller set forth in claim 20 further comprising the step of including at least one of content indicia associated with said received digital content stream and a subscriber profile in said cue.

24. The method of operating the video recording system set forth in claim 20 further comprising the step of receiving said video frames at a display controller and providing said video frames as a video sequence to a display.

25. A video processing system comprising:
a video recording system capable of (i) receiving a digital content stream comprising video track data, audio track data and content descriptor data and (ii) storing said video track data as video frames in a storage device, said video recording system comprising a commercial detection controller operable, in response to said received content descriptor data, to (i) detect a subset of said video frames associated with a commercial in said received digital content stream, and (ii) associate a cue with at least one of said subset of said video frames; and
a video playback system capable of playing back said stored video track data, and comprising a video playback controller operable to detect cues associated with ones of said subsets of said video frames and to direct said video playback system in response thereto to selectively replace said commercial with a substitute commercial during playback.

26. The video processing system set forth in claim 25 further comprising a display that is operable to display said video frames and a display controller that receives said video frames and provides said video frames as a video sequence to said display.
